(19) United States
(12) Patent Application Publication
(10) Pub. No.: US 2023/0027438 A1
(43) Pub. Date: Jan. 26, 2023

(54) SECONDARY BATTERY

(71) Applicant: MURATA MANUFACTURING CO., LTD., Kyoto (JP)

(72) Inventor: Masumi FUKUDA, Kyoto (JP)

(21) Appl. No.: 17/948,699

(22) Filed: Sep. 20, 2022

Related U.S. Application Data
(63) Continuation of application No. PCT/JP2020/042562, filed on Nov. 16, 2020.

(30) Foreign Application Priority Data
Mar. 25, 2020 (JP) 2020-054777

(51) Int. Cl. H01M 10/0567; H01M 10/0525; H01M 4/525; H01M 4/36; H01M 4/62

(52) U.S. Cl. CPC H01M 10/0567; H01M 10/0525; H01M 4/525; H01M 4/366; H01M 4/62; H01M 2300/0025; H01M 2004/028

(57) ABSTRACT

A secondary battery includes a positive electrode, a negative electrode, and an electrolytic solution. The positive electrode includes a lithium-nickel composite oxide. A first O1s spectrum, a second O1s spectrum, a b1s spectrum, a S2p spectrum, a F1s spectrum, and a Ni3p spectrum are detectable by a surface analysis of the positive electrode by X-ray photoelectron spectroscopy. The first O1s spectrum has a peak within a range of binding energy that is greater than or equal to 528 eV and less than or equal to 531 eV. The second O1s spectrum has a peak within a range of binding energy that is greater than 531 eV and less than or equal to 535 eV.

### CROSS REFERENCE TO RELATED APPLICATIONS

The present application is a continuation of PCT patent application no. PCT/JP2020/042562, filed on Nov. 16, 2020, which claims priority to Japanese patent application no. JP2020-054777, filed on Mar. 25, 2020, the entire contents of which are herein incorporated by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, various additives are added to the electrolytic solution in order to improve various kinds of performance. Examples of the additive include a boric acid compound (for example, tetraboric acid), a S═O group-containing compound (for example, sulfonic acid esters), and a lithium salt (for example, LiPF₆). In this case, materials including, without limitation, lithium nickelate and a lithium-nickel-based composite oxide are used as positive electrode active materials.

### SUMMARY

The present application relates to a secondary battery.

Although consideration has been given in various ways to improve performance of a secondary battery, a swelling characteristic of the secondary battery is not sufficient yet. Accordingly, there is still room for further improvement in terms thereof.

The present technology has been made in view of such an issue and relates to providing a secondary battery that is able to achieve a superior swelling characteristic.

A secondary battery according to an embodiment includes a positive electrode, a negative electrode, and an electrolytic solution. The positive electrode includes a lithium-nickel composite oxide. A first O1s spectrum, a second O1s spectrum, a b1s spectrum, a S2p spectrum, a F1s spectrum, and a Ni3p spectrum are detectable by a surface analysis of the positive electrode by X-ray photoelectron spectroscopy. The first O1s spectrum has a peak within a range of binding energy that is greater than or equal to 528 eV and less than or equal to 531 eV. The second O1s spectrum has a peak within a range of binding energy that is greater than 531 eV and less than or equal to 535 eV. A ratio of an intensity of the first O1s spectrum to an intensity of the second O1s spectrum is greater than or equal to 0.5 and less than or equal to 0.8, a ratio of an intensity of the B1s spectrum to an intensity of the Ni3p spectrum is greater than or equal to 0.9 and less than or equal to 1.8, a ratio of an intensity of the S2p spectrum to the intensity of the Ni3p spectrum is greater than or equal to 0.4 and less than or equal to 1.2, and a ratio of an intensity of the F1s spectrum to the intensity of the Ni3p spectrum is greater than or equal to 8 and less than or equal to 13.

The term “lithium-nickel composite oxide” is a generic term for an oxide including lithium and nickel as constituent elements. Details of the lithium-nickel composite oxide will be described later.

According to the secondary battery of an embodiment, the positive electrode includes the lithium-nickel composite oxide. Further, the above-described series of XPS spectra is detectable by the surface analysis of the positive electrode by the X-ray photoelectron spectroscopy, and the series of ratios defined on the basis of the intensities of the series of XPS spectra satisfies the above-described conditions. Accordingly, it is possible to achieve a superior swelling characteristic.

Note that effects of the present technology are not necessarily limited to those described herein and may include any of a series of suitable effects described in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

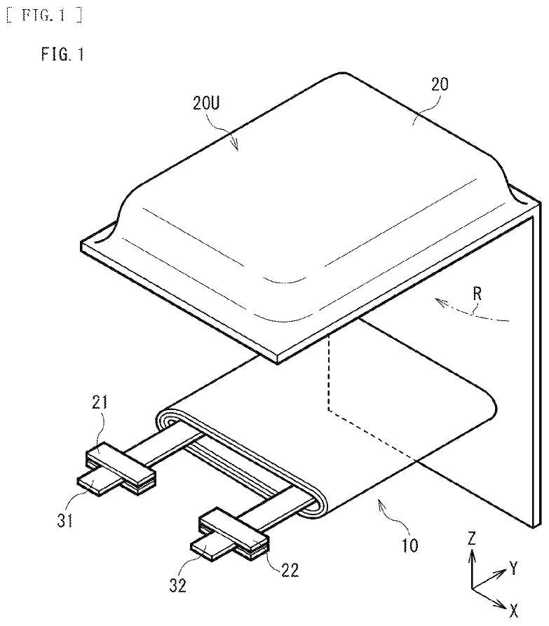

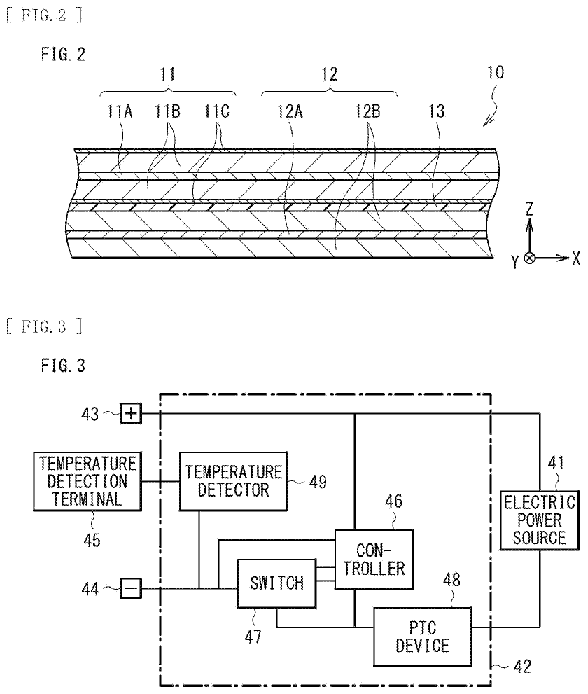

FIG. 1 illustrates a perspective configuration of the secondary battery. FIG. 2 illustrates a sectional configuration of a battery device 10 illustrated in FIG. 1. Note that FIG. 1 illustrates a state in which the battery device 10 and an outer package film 20 are separated away from each other. FIG. 2 illustrates only a portion of the battery device 10.

As illustrated in FIG. 1, the secondary battery includes the battery device 10, the outer package film 20, a positive electrode lead 31, and a negative electrode lead 32. The secondary battery described here is a secondary battery of a laminated-film type. The secondary battery of the laminated-film type includes an outer package member having flexibility or softness, that is, the outer package film 20, as an outer package member to contain the battery device 10.

The outer package film 20 is a single film-shaped member and is foldable in a direction of an arrow R (a dash-dotted line), as illustrated in FIG. 1. The outer package film 20 contains the battery device 10 as described above, and thus contains a positive electrode 11, a negative electrode 12, and an electrolytic solution that are to be described later. The outer package film 20 has a depression part 20U to place the battery device 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer opposed to each other are adhered, i.e., fusion-bonded, to each other. The outer package film 20 thus has a pouch shape that allows the battery device 10 to be sealed inside. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers.

A sealing film 21 is interposed between the outer package film 20 and the positive electrode lead 31. A sealing film 22 is interposed between the outer package film 20 and the negative electrode lead 32. The sealing films 21 and 22 are members that each prevent entry of outside air into the outer package film 20. The sealing film 21 includes one or more of polymer compounds including, without limitation, polyolefin that have adherence to the positive electrode lead 31. The sealing film 22 includes one or more of polymer compounds including, without limitation, polyolefin that have adherence to the negative electrode lead 32. Examples of the polyolefin include polyethylene, polypropylene, modified polyethylene, and modified polypropylene. Note that the sealing film 21, the sealing film 22, or both may be omitted.

As illustrated in FIGS. 1 and 2, the battery device 10 is contained inside the outer package film 20, and includes the positive electrode 11, the negative electrode 12, a separator 13, and the electrolytic solution (not illustrated). The positive electrode 11, the negative electrode 12, and the separator 13 are each impregnated with the electrolytic solution.

The battery device 10 is a wound electrode body, that is, a structure in which the positive electrode 11 and the negative electrode 12 are stacked on each other with the separator 13 interposed therebetween, and the stack of the positive electrode 11, the negative electrode 12, and the separator 13 is wound about a winding axis. Accordingly, the positive electrode 11 and the negative electrode 12 are opposed to each other with the separator 13 interposed therebetween. The winding axis is a virtual axis extending in a Y-axis direction.

The battery device 10 has an elongated three-dimensional shape. In other words, a section of the battery device 10 intersecting the winding axis, that is, a section of the battery device 10 along an XZ plane, has an elongated shape defined by a major axis and a minor axis, and more specifically, has an elongated, substantially elliptical shape. The major axis is a virtual axis that extends in an X-axis direction and has a relatively large length. The minor axis is a virtual axis that extends in a Z-axis direction intersecting the X-axis direction and has a relatively small length.

As illustrated in FIG. 2, the positive electrode 11 includes a positive electrode current collector 11A having two opposed surfaces, two positive electrode active material layers 11B and two films 11C. The two positive electrode active material layers 11B are disposed on the respective two opposed surfaces of the positive electrode current collector 11A. The two films 11C are disposed over the respective two opposed surfaces of the positive electrode current collector 11A to cover respective surfaces of the positive electrode active material layers 11B. Note that the positive electrode active material layer 11B may be disposed only on one surface, out of the two opposed surfaces of the positive electrode current collector 11A, on a side where the positive electrode 11 is opposed to the negative electrode 12.

The positive electrode current collector 11A includes one or more of electrically conductive materials including, without limitation, a metal material. Examples of the metal material include aluminum, nickel, and stainless steel. The positive electrode active material layer 11B includes one or more of positive electrode active materials into which lithium is insertable and from which lithium is extractable. The positive electrode active material layer 11B may further include, for example, a positive electrode binder and a positive electrode conductor.

The positive electrode active material includes a lithium-containing compound. More specifically, the positive electrode active material includes one or more of lithium-nickel composite oxides. The term “lithium-nickel composite oxide” is a generic term for an oxide including lithium and nickel as constituent elements, as described above, and has a layered rock-salt crystal structure. A reason why the positive electrode active material includes the lithium-nickel composite oxide is that a high energy density is obtainable.

The lithium-nickel composite oxide is not particularly limited in kind (configuration) as long as the lithium-nickel composite oxide is an oxide including lithium and nickel as constituent elements. In particular, it is preferable that the lithium-nickel composite oxide include a compound represented by Formula (1) below. A reason for this is that a sufficiently high energy density is obtainable.

Li_{w}Ni_{(1-x-y-z)}CoₓM1_{y}M2_{z}O₂ (1)

where:
M1 is Al, Mn, or both;
M2 is at least one of elements belonging to groups 2 to 15 in the long period periodic table of elements excluding Ni, Co, Al, and Mn;
w, x, y, and z satisfy 0.8≤w≤1.2, 0≤x≤0.3, 0≤y≤0.1, and 0≤z≤0.1;
a composition of lithium differs depending on a charge and discharge state; and
w is a value of a fully discharged state.

The compound (the lithium-nickel composite oxide) represented by Formula (1) is an oxide including lithium, nickel, and, on an as-needed basis, cobalt and other elements (M1 and M2) as constituent elements.

In more detail, as is apparent from a possible value range of w (0.8≤w≤1.2), the lithium-nickel composite oxide includes lithium as a constituent element.

As is apparent from a possible value range of x (0≤x≤0.3), the lithium-nickel composite oxide may include cobalt as a constituent element, or may include no cobalt as a constituent element.

As is apparent from a possible value range of y (0≤y≤0.1), the lithium-nickel composite oxide may include the other element (M1) as a constituent element, or may include no other element (M1) as a constituent element.

In particular, in a case where the lithium-nickel composite oxide includes the other element (M1) as a constituent element, the lithium-nickel composite oxide may include only aluminum as a constituent element, only manganese as a constituent element, or both aluminum and manganese as constituent elements.

As is apparent from a possible value range of z (0≤z≤0.1), the lithium-nickel composite oxide may include the other element (M2) as a constituent element, or may include no other element (M2) as a constituent element.

In particular, in a case where the lithium-nickel composite oxide includes the other element (M2) as a constituent element, the number of kinds of the other element (M2) may be one, or may be two or more.

As is apparent from the possible value range of each of x, y, and z, (1−x−y−z)>0.5 is satisfied, and the lithium-nickel composite oxide thus includes nickel as a constituent element.

Specific examples of the lithium-nickel composite oxide include LiNiO₂, LiNi_{0.70}Co_{0.30}O₀₂, LiNi_{0.80}Co_{0.05}Al_{0.5}O₂, LiNi_{0.50}Co_{0.20}Mn_{0.30}O₂, and LiNi_{0.80}C0_{0.10}Al_{0.05}Mn_{0.05}O₂.

The positive electrode active material may further include one or more of other lithium-containing compounds, as long as the positive electrode active material includes the lithium-nickel composite oxide described above.

The other lithium-containing compound is not particularly limited in kind, and specific examples thereof include a lithium-transition-metal compound. The term “lithium-transition-metal compound” is a generic term for a compound including lithium and one or more transition metal elements as constituent elements. The lithium-transition-metal compound may further include one or more other elements. The other elements may be any elements other than transition metal elements, and are not particularly limited in kind. Specifically, however, the other elements are elements belonging to groups 2 to 15 in the long period periodic table of elements. Note that the lithium-nickel composite oxide described above is excluded from the lithium-transition-metal compound described here.

The lithium-transition-metal compound is not particularly limited in kind, and specific examples thereof include an oxide, a phosphoric acid compound, a silicic acid compound, and a boric acid compound. Specific examples of the oxide include LiCoO₂, LiNi_{0.33}Co_{0.33}Mn_{0.33}P₂, Li_{1.2}Mn_{0.52}C_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

A method of forming the positive electrode active material layer 11B is not particularly limited, and specifically, includes one or more of methods including, without limitation, a coating method.

The film 11C is a film formed on the surface of the positive electrode active material layer 11B through charging and discharging of the secondary battery. More specifically, the film 11C is a film deposited on the surface of the positive electrode active material layer 11B due to, for example, a decomposition reaction of the electrolytic solution upon charging and discharging.

The film 11C is formed on the surface of the positive electrode active material layer 11B mainly as a result of charging and discharging during a stabilization process of the secondary battery to be described later, that is, initial-cycle charging and discharging after the secondary battery is assembled. Note that the film 11C may be additionally formed on the surface of the positive electrode active material layer 11B as a result of charging and discharging performed after the stabilization process of the secondary battery, that is, charging and discharging performed after the secondary battery is completed.

Note that the film 11C may cover the entire surface of the positive electrode active material layer 11B, or may cover only a portion of the surface of the positive electrode active material layer 11B. Needless to say, in the latter case, multiple films 11C may cover the surface of the positive electrode active material layer 11B at respective locations separate from each other.

Here, the film 11C is provided to cover the surface of each of the two positive electrode active material layers 11B, and the positive electrode 11 thus includes two films 11C. Note that the film 11C may be provided to cover the surface of only one of the two positive electrode active material layers 11B, and the positive electrode 11 may thus include one film 11C.

In particular, in the film 11C, specific XPS spectra (a B1s spectrum, a S2p spectrum, and a F1s spectrum) are obtained by a surface analysis of the positive electrode 11 (the film 11C) by X-ray photoelectron spectroscopy (XPS), as will be described later. Thus, the film 11C includes boron, sulfur, and fluorine as constituent elements.

More specifically, as will be described later, in a case where the electrolytic solution includes a boron-containing compound, a sulfur-containing compound, and a fluorine-containing compound, the film 11C is formed due to the decomposition reaction of such an electrolytic solution. The film 11C thus includes boron, sulfur, and fluorine as constituent elements, as described above.

In the film 11C, in order to suppress generation of gas caused by the decomposition reaction of the electrolytic solution by suppressing the decomposition reaction of the electrolytic solution on the surface of the positive electrode 11, a physical property defined by an analysis result on the positive electrode 11 (the film 11C) by XPS is made appropriate. The physical property of the positive electrode 11 (the film 11C) described here will be described in detail later.

As illustrated in FIG. 2, the negative electrode 12 includes a negative electrode current collector 12A having two opposed surfaces, and two negative electrode active material layers 12B disposed on the respective two opposed surfaces of the negative electrode current collector 12A. Note that the negative electrode active material layer 12B may be disposed only on one surface, out of the two opposed surfaces of the negative electrode current collector 12A, on a side where the positive electrode 11 is opposed to the positive electrode 11.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable. The negative electrode active material layer 12B may further include, for example, a negative electrode binder and a negative electrode conductor. Details of the negative electrode binder are similar to those of the positive electrode binder. Details of the negative electrode conductor are similar to those of the positive electrode conductor.

The negative electrode active material is not particularly limited in kind, and specific examples thereof include a carbon material and a metal-based material. Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. Such metal elements and metalloid elements are not particularly limited in kind, and specific examples thereof include silicon and tin. The metal-based material may be a simple substance, an alloy, a compound, a mixture of two or more thereof, or a material including two or more phases thereof.

Specific examples of the metal-based material include SiB₄, SiB₆, Mg₂Si, Ni2Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that “v” of SiOᵥ may satisfy 0.2<v<1.4.

A method of forming the negative electrode active material layer 12B is not particularly limited, and specifically, includes one or more of methods including, without limitation, a coating method, a vapor-phase method, a liquid-phase method, a thermal spraying method, and a firing (sintering) method.

The separator 13 is an insulating porous film interposed between the positive electrode 11 and the negative electrode 12 as illustrated in FIG. 2, and allows lithium ions to pass therethrough while preventing a contact between the positive electrode 11 and the negative electrode 12. The separator 13 includes one or more of polymer compounds including, without limitation, polytetrafluoroethylene, polypropylene, and polyethylene.

The electrolytic solution includes a solvent and an electrolyte salt.

The solvent includes one or more of non-aqueous solvents (organic solvents). An electrolytic solution including the one or more non-aqueous solvents is a so-called non-aqueous electrolytic solution. Examples of the non-aqueous solvent include esters and ethers. More specific examples of the non-aqueous solvent include a carbonic-acid-ester-based compound, a carboxylic-acid-ester-based compound, and a lactone-based compound. A reason for this is that a dissociation property of the electrolyte salt improves and a high mobility of ions is obtainable.

Specifically, examples of the carbonic-acid-ester-based compound include a cyclic carbonic acid ester and a chain carbonic acid ester. Specific examples of the cyclic carbonic acid ester include ethylene carbonate and propylene carbonate. Specific examples of the chain carbonic acid ester include dimethyl carbonate, diethyl carbonate, and methyl ethyl carbonate.

Examples of the carboxylic-acid-ester-based compound include a carboxylic acid ester. Specific examples of the carboxylic acid ester include ethyl acetate, ethyl propionate, propyl propionate, and ethyl trimethyl acetate.

Examples of the lactone-based compound include a lactone. Specific examples of the lactone include γ-butyrolactone and γ-valerolactone. Note that examples of the ethers other than the lactone-based compounds described above may include 1,2-dimethoxyethane, tetrahydrofuran, 1,3-dioxolane, and 1,4-dioxane.

Further, examples of the non-aqueous solvent may include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specifically, examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one). Examples of the halogenated carbonic acid ester include fluoroethylene carbonate (4-fluoro-1,3-dioxolane-2-one) and difluoroethylene carbonate (4,5-difluoro-1,3-dioxolane-2-one). Examples of the sulfonic acid ester include 1,3-propane sultone and 1,3-propene sultone. Examples of the phosphoric acid ester include trimethyl phosphate and triethyl phosphate.

Examples of the acid anhydride include a cyclic dicarboxylic acid anhydride, a cyclic disulfonic acid anhydride, and a cyclic carboxylic acid sulfonic acid anhydride. Examples of the cyclic dicarboxylic acid anhydride include succinic anhydride, glutaric anhydride, and maleic anhydride. Examples of the cyclic disulfonic acid anhydride include 1,2-ethanedisulfonic anhydride and 1,3-propanedisulfonic anhydride. Examples of the cyclic carboxylic acid sulfonic acid anhydride include sulfobenzoic anhydride, sulfopropionic anhydride, and sulfobutyric anhydride.

Examples of the nitrile compound include acetonitrile, succinonitrile, and adiponitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium difluoro(oxalato)borate (LiBF₂(C₂O₄)), and lithium bis(oxalato)borate (LiB(C₂O₄)₂).

Although not particularly limited, a content of the electrolyte salt is specifically within a range from 0.3 mol/kg to 3.0 mol/kg both inclusive with respect to the solvent. A reason for this is that a high ionic conductivity is obtainable.

In order to obtain the above-described physical property on the basis of the result of the surface analysis of the positive electrode 11 (the film 11C) by XPS, the electrolytic solution may include the boron-containing compound, the sulfur-containing compound, and the fluorine-containing compound. Details of each of the boron-containing compound, the sulfur-containing compound, and the fluorine-containing compound described here will be described later.

The positive electrode lead 31 is a positive electrode terminal coupled to the positive electrode 11 (the positive electrode current collector 11A), and includes one or more of electrically conductive materials including, without limitation, aluminum. The negative electrode lead 32 is a negative electrode terminal coupled to the negative electrode 12 (the negative electrode current collector 12A), and includes one or more of electrically conductive materials including, without limitation, copper, nickel, and stainless steel. A shape of each of the positive electrode lead 31 and the negative electrode lead 32 is not particularly limited, and specifically, is one or more of shapes including, without limitation, a thin plate shape and a meshed shape.

Here, as illustrated in FIG. 1, the positive electrode lead 31 and the negative electrode lead 32 are led out in respective directions that are common to each other, from an inside to an outside of the outer package film 20. Note that the positive electrode lead 31 and the negative electrode lead 32 may be led out in respective directions that are different from each other.

Here, the number of the positive electrode leads 31 is one. The number of the positive electrode leads 31 is, however, not particularly limited, and may be two or more. In particular, if the number of the positive electrode leads 31 is two or more, the secondary battery decreases in electrical resistance. The description given here in relation to the number of the positive electrode leads 31 also applies to the number of the negative electrode leads 32. Accordingly, the number of the negative electrode leads 32 may be two or more, without being limited to one.

In the secondary battery, the physical property defined by the result of the surface analysis of the positive electrode 11 (the film 11C) by XPS is made appropriate, as described above.

Specifically, the following six XPS spectra are detectable by the surface analysis of the positive electrode 11 (the film 11C) by XPS.

A first XPS spectrum is an O1s spectrum attributable to oxygen, more specifically, a first O1s spectrum having a peak within a range of binding energy that is greater than or equal to 528 eV and less than or equal to 531 eV. The first O1s spectrum is considered to be detected mainly due to, for example, a constituent component of the positive electrode active material layer 11B (the lithium-nickel composite oxide as the positive electrode active material), a bonding state of oxygen atoms in the crystal structure of the positive electrode active material, and a constituent component of the film 11C.

A second XPS spectrum is another O1s spectrum attributable to oxygen, more specifically, a second O1s spectrum having a peak within a range of binding energy that is greater than 531 eV and less than or equal to 535 eV. Similarly to the above-described first O1s spectrum, the second O1s spectrum is considered to be detected mainly due to, for example, the constituent component of the positive electrode active material layer 11B (the positive electrode active material), the bonding state of oxygen atoms in the crystal structure of the positive electrode active material, and the constituent component of the film 11C.

A third XPS spectrum is the B1s spectrum attributable to boron. The 1s spectrum is considered to be detected mainly due to the constituent component of the film 11C.

A fourth XPS spectrum is the S2p spectrum attributable to sulfur. The S1s spectrum is considered to be detected mainly due to the constituent component of the film 11C.

A fifth XPS spectrum is the F1s spectrum attributable to fluorine. The F1s spectrum is considered to be detected mainly due to the constituent component of the film 11C, and the constituent component of the film 11C is considered to be, for example, LiF.

A sixth XPS spectrum is a Ni3p spectrum attributable to nickel. The Ni3p spectrum is considered to be detected mainly due to, for example, the constituent component of the positive electrode active material layer 11B (the positive electrode active material), and a bonding state of nickel atoms in the crystal structure of the positive electrode active material.

In this case, four ratios (intensity ratios) defined on the basis of respective intensities of the six XPS spectra satisfy the following conditions.

First, an intensity ratio IO (=IO1/IO2), which is a ratio of an intensity IO1 of the first O1s spectrum to an intensity IO2 of the second O1s spectrum, is within a range from 0.5 to 0.8 both inclusive.

Second, an intensity ratio IBN (=IB/IN), which is a ratio of an intensity IB of the B1s spectrum to an intensity IN of the Ni3p spectrum, is within a range from 0.9 to 1.8 both inclusive.

Third, an intensity ratio ISN (=IS/IN), which is a ratio of an intensity IS of the S2p spectrum to the intensity IN of the Ni3p spectrum, is within a range from 0.4 to 1.2 both inclusive.

Fourth, an intensity ratio IFN (=IF/IN), which is a ratio of an intensity IF of the F1s spectrum to the intensity IN of the Ni3p spectrum, is within a range from 8 to 13 both inclusive.

A reason why the intensity ratios IO, IBN, ISN, and IFN satisfy the above-described conditions is that the respective bonding states (the respective oxidized states) of constituent atoms such as oxygen atoms or nickel atoms in the crystal structure of the positive electrode active material are made appropriate in the positive electrode 11 including the positive electrode active material (the lithium-nickel composite oxide). This stabilizes the crystal structure of the positive electrode active material, and electrochemically stabilizes a surface state of the positive electrode 11 by using the film 11C. As a result, the decomposition reaction of the electrolytic solution on the surface of the positive electrode 11 is suppressed upon charging and discharging, and this suppresses the generation of gas caused by the decomposition reaction of the electrolytic solution. This suppresses swelling of the secondary battery upon charging and discharging even if the positive electrode 11 includes the lithium-nickel composite oxide.

Here, in order to allow the B1s spectrum, the S2p spectrum, and the F1s spectrum described above to be detectable by the surface analysis of the positive electrode 11 by XPS, the electrolytic solution may include the boron-containing compound, the sulfur-containing compound, and the fluorine-containing compound.

The term “boron-containing compound” is a generic term for a compound including boron as a constituent element. The boron-containing compound is not particularly limited in kind, and specifically, includes one or more of compounds including, without limitation, a boron-containing lithium salt.

Specific examples of the boron-containing lithium salt include lithium tetrafluoroborate, lithium difluoro(oxalato)borate, and lithium bis(oxalato)borate, which have been described above as examples of the electrolyte salt.

The term “sulfur-containing compound” is a generic term for a compound including sulfur as a constituent element. The sulfur-containing compound is not particularly limited in kind, and specifically, includes one or more of compounds including, without limitation, a cyclic disulfonic acid anhydride and an alkynyl sulfonic acid. In other words, the sulfur-containing compound may include only the cyclic disulfonic acid anhydride, only the alkynyl sulfonic acid, or both the cyclic disulfonic acid anhydride and the alkynyl sulfonic acid.

The cyclic disulfonic acid anhydride is a cyclic compound resulting from dehydration of a disulfonic acid anhydride. Specific examples of the cyclic disulfonic acid anhydride include 1,2-ethanedisulfonic anhydride and 1,3-propanedisulfonic anhydride, which have been described above as examples of the non-aqueous solvent. Examples of the cyclic disulfonic acid anhydride may also include 1,2-benzenedisulfonic anhydride.

The alkynyl sulfonic acid is a sulfonic acid including a carbon-carbon triple bond. Specific examples of the alkynyl sulfonic acid include propargyl benzenesulfonate and propargyl methanesulfonate.

The term “fluorine-containing compound” is a generic term for a compound including fluorine as a constituent element. The fluorine-containing compound is not particularly limited in kind, and specifically, includes one or more of compounds including, without limitation, a fluorine-containing lithium salt.

Specific examples of the fluorine-containing lithium salt include lithium hexafluorophosphate, lithium trifluoromethanesulfonate, lithium bis(fluorosulfonyl)imide, lithium bis(trifluoromethanesulfonyl)imide, and lithium tris(trifluoromethanesulfonyl)methide, which have been described above as examples of the electrolyte salt. Examples of the fluorine-containing lithium salt may also include lithium hexafluoroarsenate (LiAsF₆).

However, a compound including both boron and fluorine as constituent elements shall fall under the category of the boron-containing compound rather than the fluorine-containing compound. Accordingly, the lithium salt (the lithium tetrafluoroborate) including both boron and fluorine as constituent elements is not the fluorine-containing compound (the fluorine-containing lithium salt) but the boron-containing compound (the boron-containing lithium salt), as described above.

A content of the boron-containing compound in the electrolytic solution is not particularly limited, and may thus be set as desired. The same applies to a content of the sulfur-containing compound in the electrolytic solution, and to a content of the fluorine-containing compound in the electrolytic solution.

Note that, for purpose of understanding, the electrolytic solution does not necessarily have to include the boron-containing compound, the sulfur-containing compound, and the fluorine-containing compound, as long as the six XPS spectra are detectable by the surface analysis of the positive electrode 11 by XPS and the four intensity ratios satisfy the above-described conditions. In this case, the electrolytic solution may include not all of the boron-containing compound, the sulfur-containing compound, and the fluorine-containing compound, and the electrolytic solution may include only one or two of the boron-containing compound, the sulfur-containing compound, or the fluorine-containing compound.

Specifically, the electrolytic solution may initially include the boron-containing compound, the sulfur-containing compound, and the fluorine-containing compound, but all of the boron-containing compound, the sulfur-containing compound, and the fluorine-containing compound may be consumed in forming the film 11C upon charging and discharging in the stabilization process of the secondary battery. In such a case, the electrolytic solution in the completed secondary battery may include none of the boron-containing compound, the sulfur-containing compound, and the fluorine-containing compound.

Again, the electrolytic solution may initially include the boron-containing compound, the sulfur-containing compound, and the fluorine-containing compound, but any one or two of the boron-containing compound, the sulfur-containing compound, or the fluorine-containing compound may be consumed in forming the film 11C upon charging and discharging in the stabilization process of the secondary battery. In such a case, the electrolytic solution in the completed secondary battery may include only the remaining one or two of the boron-containing compound, the sulfur-containing compound, or the fluorine-containing compound.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging the secondary battery, lithium is inserted and extracted in an ionic state.

In a case of manufacturing the secondary battery, the positive electrode 11 and the negative electrode 12 are fabricated and the electrolytic solution is prepared, following which the secondary battery is fabricated using the positive electrode 11, the negative electrode 12, and the electrolytic solution, according to a procedure to be described below.

Here, a case where the lithium-nickel composite oxide as the positive electrode active material includes cobalt and other elements (M1 and M2) as constituent elements is given as an example.

First, as raw materials, a lithium source (a lithium compound), a nickel source (a nickel compound), a cobalt source (a cobalt compound), a source of the other element (M1) (a first other element compound), and a source of the other element (M2) (a second other element compound) are prepared.

The lithium compound may be, for example, an inorganic compound or an organic compound. Only one lithium compound may be used, or two or more lithium compounds may be used. Specific examples of the lithium compound as the inorganic compound include lithium hydroxide, lithium carbonate, lithium nitrate, lithium fluoride, lithium chloride, lithium bromide, lithium iodide, lithium chlorate, lithium perchlorate, lithium bromate, lithium iodate, lithium oxide, lithium peroxide, lithium sulfide, lithium hydrogen sulfide, lithium sulfate, lithium hydrogen sulfate, lithium nitride, lithium azide, lithium nitrite, lithium phosphate, lithium dihydrogen phosphate, and lithium bicarbonate. Specific examples of the lithium compound as the organic compound include methyllithium, vinyllithium, isopropyllithium, butyllithium, phenyllithium, lithium oxalate, and lithium acetate.

What has been described here with respect to the lithium compound is similarly applicable to each of the nickel compound, the cobalt compound, the first other element compound, and the second other element compound. That is, the compounds such as the nickel compound may each be an inorganic compound or an organic compound. For each of the compounds such as the nickel compound, only one relevant compound may be used, or two or more relevant compounds may be used. Further, specific examples of each of the compounds such as the nickel compound include compounds in which “lithium” in each of the above-described specific examples of the lithium compound is replaced with the relevant element such as “nickel”.

Thereafter, the lithium compound, the nickel compound, the cobalt compound, the first other element compound, and the second other element compound are mixed to thereby obtain a precursor. A mixture ratio between the lithium compound, the nickel compound, the cobalt compound, the first other element compound, and the second other element compound is determined in accordance with a composition of the lithium-nickel composite oxide to be finally obtained.

Thereafter, the precursor is fired. Conditions including, without limitation, a firing temperature may be set as desired. The compound (lithium-nickel composite oxide) which includes lithium, nickel, cobalt, and the other elements (M1 and M2) as constituent elements is thereby synthesized. The positive electrode active material (the lithium-nickel composite oxide) is thus obtained.

In this case, each of the intensity IO1 of the first O1s spectrum and the intensity IO2 of the second O1s spectrum is varied by changing conditions including, without limitation, the firing temperature described above. The intensity ratio IO is thus adjustable. The intensity IN of the Ni3p spectrum is also varied by changing conditions including, without limitation, a firing temperature and a firing time.

Note that in a case of synthesizing the positive electrode active material (the lithium-nickel composite oxide), the intensity IN of the Ni3p spectrum is varied by changing the composition of the lithium-nickel composite oxide, i.e., a content of nickel. Each of the intensity ratios IBN, ISN, and IFN is thus adjustable.

Thereafter, the positive electrode active material (the lithium-nickel composite oxide) described above is mixed with materials including, without limitation, the positive electrode binder and the positive electrode conductor to thereby obtain a positive electrode mixture. Thereafter, the positive electrode mixture is put into a solvent such as an organic solvent to thereby prepare a paste positive electrode mixture slurry. Thereafter, the positive electrode mixture slurry is applied on the two opposed surfaces of the positive electrode current collector 11A to thereby form the positive electrode active material layers 11B. Thereafter, the positive electrode active material layers 11B may be compression-molded by means of, for example, a roll pressing machine. In this case, the positive electrode active material layers 11B may be heated. The positive electrode active material layers 11B may be compression-molded multiple times. Lastly, the stabilization process of the secondary battery to be described later is performed to thereby form the film 11C on each of the respective surfaces of the positive electrode active material layers 11B. In this manner, the positive electrode active material layers 11B are formed on the respective two opposed surfaces of the positive electrode current collector 11A, and the films 11C are formed over the respective two opposed surfaces of the positive electrode current collector 11A. Thus, the positive electrode 11 is fabricated.

The negative electrode active material layers 12B are formed on the respective two opposed surfaces of the negative electrode current collector 12A by a procedure substantially similar to the fabrication procedure of the positive electrode 11 described above. Specifically, the negative electrode active material is mixed with materials including, without limitation, the negative electrode binder and the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on the two opposed surfaces of the negative electrode current collector 12A to thereby form the negative electrode active material layers 12B. Thereafter, the negative electrode active material layers 12B may be compression-molded. The negative electrode active material layers 12B are thus formed on the respective two opposed surfaces of the negative electrode current collector 12A. In this manner, the negative electrode 12 is fabricated.

The materials including, without limitation, the electrolyte salt is put into the solvent, following which the boron-containing compound, the sulfur-containing compound, and the fluorine-containing compound are added to the solvent. The materials including, without limitation, the electrolyte salt, the boron-containing compound, the sulfur-containing compound, and the fluorine-containing compound are thereby dispersed or dissolved in the solvent. As a result, the electrolytic solution is prepared.

Note that in a case where the boron-containing lithium salt is used as the boron-containing compound, the boron-containing lithium salt may also serve as the electrolyte salt. Similarly, in a case where the fluorine-containing lithium salt is used as the fluorine-containing compound, the fluorine-containing lithium salt may also serve as the electrolyte salt.

In this case, the intensity IB of the B1s spectrum is varied by changing the above-described content of the boron-containing compound. The intensity ratio IBN is thus adjustable. Further, the intensity IS of the S2p spectrum is varied by changing the above-described content of the sulfur-containing compound. The intensity ratio ISN is thus adjustable. Moreover, the intensity IF of the F1s spectrum is varied by changing the above-described content of the fluorine-containing compound. The intensity ratio IFN is thus adjustable.

As described above, upon synthesizing the positive electrode active material, the intensity IN varies depending on the variation in conditions including, without limitation, the firing temperature. Thus, it is possible to adjust each of the intensity ratios IBN, ISN, and IFN by varying the intensity IN.

First, the positive electrode lead 31 is coupled to the positive electrode 11 (the positive electrode current collector 11A) by a method such as a welding method, and the negative electrode lead 32 is coupled to the negative electrode 12 (the negative electrode current collector 12A) by a method such as a welding method.

Thereafter, the positive electrode 11 and the negative electrode 12 are stacked on each other with the separator 13 interposed therebetween, following which the stack of the positive electrode 11, the negative electrode 12, and the separator 13 is wound to thereby fabricate a wound body. The wound body has a configuration similar to that of the battery device 10 except that the positive electrode 11, the negative electrode 12, and the separator 13 are each not impregnated with the electrolytic solution. Thereafter, the wound body is pressed by means of, for example, a pressing machine to thereby shape the wound body into an elongated shape.

Thereafter, the wound body is placed inside the depression part 20U, following which the outer package film 20 (fusion-bonding layer/metal layer/surface protective layer) is folded to thereby cause portions of the outer package film 20 to be opposed to each other. Thereafter, outer edges of two sides of the outer package film 20 (the fusion-bonding layer) opposed to each other are bonded to each other by a method such as a thermal-fusion-bonding method to thereby contain the wound body in the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 31, and the sealing film 22 is interposed between the outer package film 20 and the negative electrode lead 32. The wound body is thereby impregnated with the electrolytic solution. Thus, the battery device 10 which is the wound electrode body is fabricated. In this manner, the battery device 10 is sealed in the pouch-shaped outer package film 20. As a result, the secondary battery is assembled.

The assembled secondary battery is charged and discharged to thereby perform the stabilization process of the secondary battery. Various conditions including, for example, an environment temperature, the number of times of charging and discharging (the number of cycles), and charging and discharging conditions may be set as desired. This process forms the film 11C on each of the respective surfaces of the positive electrode active material layers 11B, as described above. As a result, the positive electrode 11 is fabricated. In this case, a film is also formed on a surface of the negative electrode 12. This brings the secondary battery into an electrochemically stable state. The secondary battery including the outer package film 20, that is, the secondary battery of the laminated-film type, is thus completed.

The secondary battery includes the positive electrode 11 that includes the positive electrode active material (the lithium-nickel composite oxide). The six XPS spectra (the first O1s spectrum, the second O1s spectrum, the B1s spectrum, the S2p spectrum, the F1s spectrum, and the Ni3p spectrum) are detectable by the surface analysis of the positive electrode 11 by XPS, and the four intensity ratios (the intensity ratios IO, IBN, ISN, and IFN) satisfy the above-described conditions.

In this case, as described above, the bonding state (the oxidized state) of the constituent atoms such as the oxygen atoms and the nickel atoms in the crystal structure of the positive electrode active material is made appropriate in the positive electrode 11 including the positive electrode active material (the lithium-nickel composite oxide). This stabilizes the crystal structure of the positive electrode active material, and electrochemically stabilizes the surface state of the positive electrode 11. As a result, the decomposition reaction of the electrolytic solution on the surface of the positive electrode 11 is suppressed upon charging and discharging, which suppresses the generation of gas caused by the decomposition reaction of the electrolytic solution. This suppresses swelling of the secondary battery upon charging and discharging even if the positive electrode 11 includes the lithium-nickel composite oxide. Accordingly, it is possible to obtain a superior swelling characteristic.

In particular, the positive electrode 11 may include the positive electrode active material layer 11B including the lithium-nickel composite oxide, and the film 11C including boron, sulfur, and fluorine as constituent elements, and the surface analysis of the positive electrode 11 by XPS may include the analysis of the film 11C. This helps to electrochemically stabilize the surface state of the positive electrode 11 easily by using the film 11C. Accordingly, it is possible to achieve higher effects.

Further, the lithium-nickel composite oxide may include the compound represented by Formula (1). This helps to obtain a sufficiently high energy density. Accordingly, it is possible to achieve higher effects.

Further, the electrolytic solution may include the boron-containing compound, the sulfur-containing compound, and the fluorine-containing compound. This allows the six XPS spectra to be easily detected and the four intensity ratios to easily satisfy the above-described conditions. Accordingly, it is possible to achieve higher effects.

In this case, the boron-containing compound may include the boron-containing lithium salt, the sulfur-containing compound may include the cyclic disulfonic acid anhydride, the alkynyl sulfonic acid, or both, and the fluorine-containing compound may include the fluorine-containing lithium salt. This allows the six XPS spectra to be easily and stably detected and the four intensity ratios to more easily satisfy the above-described conditions. Accordingly, it is possible to achieve further higher effects.

Further, the secondary battery may include the outer package film 20, and the battery device 10 (the positive electrode 11, the negative electrode 12, and the electrolytic solution) may be contained inside the outer package film 20. This effectively prevents the secondary battery from easily swelling even if the outer package film 20 which easily causes noticeable swelling is used. Accordingly, it is possible to achieve higher effects.

The secondary battery may include a lithium-ion secondary battery. This makes it possible to obtain a sufficient battery capacity stably through the use of insertion and extraction of lithium. Accordingly, it is possible to achieve higher effects.

Next, a description is given of modifications of the above-described secondary battery. The configuration of the secondary battery is appropriately modifiable as described below. Note that any two or more of the following series of modifications may be combined with each other.

The separator 13 which is a porous film is used. However, although not specifically illustrated here, a separator of a stacked type including a polymer compound layer may be used instead of the separator 13 which is the porous film.

Specifically, the separator of the stacked type includes a porous film having two opposed surfaces, and a polymer compound layer disposed on one of or each of the two opposed surfaces of the porous film. A reason for this is that adherence of the separator to each of the positive electrode 11 and the negative electrode 12 improves to suppress the occurrence of misalignment of the battery device 10. This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that such insulating particles dissipate heat upon heat generation by the secondary battery, thus improving safety or heat resistance of the secondary battery. Examples of the insulating particles include inorganic particles and resin particles. Specific examples of the inorganic particles include particles of aluminum oxide, aluminum nitride, boehmite, silicon oxide, titanium oxide, magnesium oxide, and zirconium oxide. Specific examples of the resin particles include particles of acrylic resin and styrene resin.

In a case of fabricating the separator of the stacked type, a precursor solution including, without limitation, the polymer compound and an organic solvent is prepared, following which the precursor solution is applied on one of or each of the two opposed surfaces of the porous film. In another example, the porous film may be immersed in the precursor solution. In this case, insulating particles may be added to the precursor solution on an as-needed basis.

In the case where the separator of the stacked type is used also, lithium ions are movable between the positive electrode 11 and the negative electrode 12, and similar effects are therefore obtainable.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are stacked on each other with the separator 13 and the electrolyte layer interposed therebetween, following which the stack of the positive electrode 11, the negative electrode 12, the separator 13, and the electrolyte layer is wound. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and an organic solvent is prepared, following which the precursor solution is applied on one of or each of the two opposed surfaces of the positive electrode 11 and on one of or each of the two opposed surfaces of the negative electrode 12.

In a case where the electrolyte layer is used also, lithium ions are movable between the positive electrode 11 and the negative electrode 12 via the electrolyte layer, and similar effects are therefore obtainable.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. Note that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are merely examples, and are appropriately modifiable.

FIG. 3 illustrates a block configuration of a battery pack. The battery pack described here is a simple battery pack (a so-called soft pack) including one secondary battery, and is to be mounted on, for example, electronic equipment typified by a smartphone.

As illustrated in FIG. 3, the battery pack includes an electric power source 41 and a circuit board 42. The circuit board 42 is coupled to the electric power source 41, and includes a positive electrode terminal 43, a negative electrode terminal 44, and a temperature detection terminal 45. The temperature detection terminal 45 is a so-called T terminal.

The electric power source 41 includes one secondary battery. The secondary battery has a positive electrode lead coupled to the positive electrode terminal 43 and a negative electrode lead coupled to the negative electrode terminal 44. The electric power source 41 is couplable to outside via the positive electrode terminal 43 and the negative electrode terminal 44, and is thus chargeable and dischargeable via the positive electrode terminal 43 and the negative electrode terminal 44. The circuit board 42 includes a controller 46, a switch 47, a thermosensitive resistive device (a positive temperature coefficient (PTC) device) 48, and a temperature detector 49. However, the PTC device 48 may be omitted.

The controller 46 includes, for example, a central processing unit (CPU) and a memory, and controls an overall operation of the battery pack. The controller 46 detects and controls a use state of the electric power source 41 on an as-needed basis.

If a battery voltage of the electric power source 41 (the secondary battery) reaches an overcharge detection voltage or an overdischarge detection voltage, the controller 46 turns off the switch 47. This prevents a charging current from flowing into a current path of the electric power source 41. In addition, if a large current flows upon charging or discharging, the controller 46 turns off the switch 47 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 47 includes, for example, a charge control switch, a discharge control switch, a charging diode, and a discharging diode. The switch 47 performs switching between coupling and decoupling between the electric power source 41 and external equipment in accordance with an instruction from the controller 46. The switch 47 includes, for example, a metal-oxide-semiconductor field-effect transistor (MOSFET). The charging and discharging currents are detected on the basis of an ON-resistance of the switch 47.

The temperature detector 49 includes a temperature detection device such as a thermistor. The temperature detector 49 measures a temperature of the electric power source 41 using the temperature detection terminal 45, and outputs a result of the temperature measurement to the controller 46. The result of the temperature measurement to be obtained by the temperature detector 49 is used, for example, in a case where the controller 46 performs charge/discharge control upon abnormal heat generation or in a case where the controller 46 performs a correction process upon calculating a remaining capacity.

### EXAMPLES

A description is provided below of Examples of the present technology according to an embodiment.

### Experiment Examples 1 to 70

Secondary batteries (lithium-ion secondary batteries) of the laminated-film type illustrated in FIGS. 1 and 2 were fabricated, following which the secondary batteries were each evaluated for performance as described below.

### [Fabrication of Secondary Battery]

The secondary batteries were fabricated in accordance with the following procedure.

### (Fabrication of Positive Electrode)

First, as raw materials, the lithium compound (lithium sulfate), the nickel compound (nickel sulfate), the cobalt compound (cobalt sulfate), and the first other element compound (aluminum sulfate) were prepared. Thereafter, the lithium compound, the nickel compound, the cobalt compound, the first other element compound, and the second other element compound were mixed to thereby obtain a precursor. In this case, the mixture ratio was adjusted in such a manner as to finally synthesize the lithium-nickel composite oxide (LiNi0.80Co_{0.15}Al_{0.05}O₂) to be described later. Lastly, the precursor was fired to thereby synthesize the lithium-nickel composite oxide (LiNi_{0.80}Co_{0.15}Al_{0.05}O₂). The positive electrode active material (the lithium-nickel composite oxide) was thus obtained.

In this case, the firing temperature was changed within a range from 650° C. to 800° C. both inclusive to thereby vary the intensity ratio IO as indicated in Tables 1 to 5.

Thereafter, 91 parts by mass of the above-described positive electrode active material, 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on the two opposed surfaces of the positive electrode current collector 11A (a strip-shaped aluminum foil having a thickness of 12 μm) by means of a coating apparatus, following which the applied positive electrode mixture slurry was dried to thereby form the positive electrode active material layers 11B. Thereafter, the positive electrode active material layers 11B were compression-molded by means of a roll pressing machine. Lastly, the films 11C were formed in the stabilization process of the secondary battery to be described later. In this manner, the positive electrode active material layers 11B were formed on the respective two opposed surfaces of the positive electrode current collector 11A, and the films 11C were formed over the respective two opposed surfaces of the positive electrode current collector 11A. Thus, the positive electrode 11 was fabricated.Fabrication of Negative Electrode)

First, 93 parts by mass of the negative electrode active material (artificial graphite as the carbon material) and 7 parts by mass of the negative electrode binder (polyvinylidene difluoride) were mixed with each other, to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on the two opposed surfaces of the negative electrode current collector 12A (a strip-shaped copper foil having a thickness of 15 μm) by means of a coating apparatus, following which the applied negative electrode mixture slurry was dried to thereby form the negative electrode active material layers 12B. Lastly, the negative electrode active material layers 12B were compression-molded by means of the roll pressing machine. In this manner, the negative electrode active material layers 12B were formed on the respective two opposed surfaces of the negative electrode current collector 12A. Thus, the negative electrode 12 was fabricated.

### (Preparation of Electrolytic Solution)

The boron-containing compound, the sulfur-containing compound, and the fluorine-containing compound were added to the solvent (ethylene carbonate as the cyclic carbonic acid ester and diethyl carbonate as the chain carbonic acid ester), following which the solvent was stirred. A mixture ratio (a weight ratio) of the solvent between ethylene carbonate and diethyl carbonate was set to 50:50.

As the boron-containing compound, the boron-containing lithium salt serving as the electrolyte salt was used. The kind and the content (wt %) of the boron-containing lithium salt were as indicated in Tables 1 to 5. Used as the boron-containing lithium salt were lithium tetrafluoroborate (LiBF₄), lithium difluoro(oxalato)borate (LiFOB), and lithium bis(oxalato)borate (LiBOB). The above-described “content (wt %)” is a content (wt %) in a case where the solvent is set to 100 wt %, and this is also similarly applicable hereinafter.

As the sulfur-containing compound, the cyclic disulfonic acid anhydride and the alkynyl sulfonic acid were used. The respective kinds and the respective contents (wt %) of the cyclic disulfonic acid anhydride and the alkynyl sulfonic acid were as indicated in Tables 1 to 5. Used as the cyclic disulfonic acid anhydride were 1,3-propanedisulfonic anhydride (PSAH) and 1,2-ethanedisulfonic anhydride (ESAH). Used as the alkynyl sulfonic acid was propargyl benzenesulfonate (PBS).

As the fluorine-containing compound, the fluorine-containing lithium salt serving as the electrolyte salt was used. The kind and the content (wt %) of the fluorine-containing lithium salt were as indicated in Tables 1 to 5. Used as the fluorine-containing lithium salt were lithium hexafluorophosphate (LiPF₆), lithium bis(fluorosulfonyl)imide (LiFSI), and lithium tris(trifluoromethanesulfonyl)methide (LiFSC).

Each of the boron-containing compound, the sulfur-containing compound, and the fluorine-containing compound was thus dispersed or dissolved in the solvent. As a result, the electrolytic solution was prepared.

In this case, the intensity ratios IBN, ISN, and IFN were each varied as indicated in Tables 1 to 5 by changing the respective contents of the boron-containing compound, the sulfur-containing compound, and the fluorine-containing compound. Note that upon synthesizing the positive electrode active material described above, the intensity IN varied depending on the variation in the firing temperature. Thus, the variation in the intensity IN also varied each of the intensity ratios IBN, ISN, and IFN.

For comparison, the electrolytic solution was prepared by a similar procedure except that the boron-containing compound, the sulfur-containing compound, and the fluorine-containing compound were not used.

### (Assembly of Secondary Battery)

First, the positive electrode lead 31 including aluminum was welded to the positive electrode 11 (the positive electrode current collector 11A), and the negative electrode lead 32 including copper was welded to the negative electrode 12 (the negative electrode current collector 12A).

Thereafter, the positive electrode 11 and the negative electrode 12 were stacked on each other with the separator 13 (a fine-porous polyethylene film having a thickness of 15 um) interposed therebetween, following which the stack of the positive electrode 11, the negative electrode 12, and the separator 13 was wound to thereby fabricate the wound body. Thereafter, the wound body was pressed by means of a pressing machine, and was thereby shaped into an elongated shape.

Thereafter, the wound body was placed inside the depression part 20U of the outer package film 20. As the outer package film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order. Thereafter, the outer package film 20 was folded in such a manner as to sandwich the wound body and to have the fusion-bonding layer on the inner side, following which the outer edges of two sides of the outer package film 20 (the fusion-bonding layer) were thermal-fusion-bonded to each other to thereby allow the wound body to be contained inside the pouch-shaped outer package film 20.

Lastly, the electrolytic solution was injected into the pouch-shaped outer package film 20 and thereafter, the outer edges of the remaining one side of the outer package film 20 (the fusion-bonding layer) were thermal-fusion-bonded to each other in a reduced-pressure environment. In this case, the sealing film 21 (a polypropylene film having a thickness of 5 μm) was interposed between the outer package film 20 and the positive electrode lead 31, and the sealing film 22 (a polypropylene film having a thickness of 5 μm) was interposed between the outer package film 20 and the negative electrode lead 32. The wound body was thereby impregnated with the electrolytic solution. Thus, the battery device 10 was fabricated. In this manner, the battery device 10 was sealed in the outer package film 20, and the secondary battery was thus assembled.

### (Stabilization Process)

The secondary battery was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

In this manner, the films 11C were formed on the respective surfaces of the positive electrode active material layers 11B. Accordingly, the positive electrode active material layers 11B were formed on the respective two opposed surfaces of the positive electrode current collector 11A, and the films 11C were formed over the respective two opposed surfaces of the positive electrode current collector 11A. The positive electrode 11 was thus fabricated. As a result, the state of the secondary battery was stabilized, and the secondary battery of the laminated-film type was thus completed.

Evaluation of the performance (swelling characteristic) of the secondary batteries revealed the results presented in Tables 1 to 5.

After the secondary battery was completed, the secondary battery was disassembled prior to examination of the swelling characteristic to thereby collect the positive electrode 11. Thereafter, the surface analysis of the positive electrode 11 was performed by XPS. On the basis of the results of the surface analysis of the positive electrode 11, the respective intensities of the six XPS spectra (the first O1s spectrum, the second O1s spectrum, the B1s spectrum, the S2p spectrum, the F1s spectrum, and the Ni3p spectrum) were measured, following which the four intensity ratios (the intensity ratios IO, IBN, ISN, and IFN) were calculated on the basis of the measurement results. The calculation results of the intensity ratios IO, IBN, ISN, and IFN were as indicated in Tables 1 to 5.

In a case of examining the swelling characteristic, first, the secondary battery was charged in an ambient temperature environment, following which a thickness (a pre-storage thickness) of the secondary battery was measured. Thereafter, the secondary battery in the charged state was stored for a storing period of 24 hours in a high-temperature environment (at a temperature of 60° C.), following which the thickness (a post-storage thickness) of the secondary battery was measured again. Lastly, the following was calculated: swelling rate (%)=(post-storage thickness/pre-storage thickness)×100−100. Note that charging conditions were similar to those in the case of performing the stabilization process of the secondary battery described above.

TABLE 1
Positive electrode active material: LiNi_{0.80}Co_{0.15}Al_{0.05}O₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 1 | LiBF₄ | 1 | PSAH | 1 | LiPF₆ | 15 | 0.4 | 0.8 | 0.4 | 8.8 | 32 |
| 2 | | | | | | | 0.5 | 0.9 | 0.4 | 9.9 | 15 |
| 3 | | | | | | | 0.6 | 1.0 | 0.4 | 11.0 | 15 |
| 4 | | | | | | | 0.8 | 1.2 | 0.4 | 12.2 | 18 |
| 5 | | | | | | | 0.9 | 1.3 | 0.4 | 13.3 | 26 |
| 6 | LiBF₄ | 0.3 | PSAH | 1 | LiPF₆ | 15 | 0.6 | 0.8 | 0.5 | 11 | 80 |
| 7 | | 0.5 | | | | | 0.6 | 0.9 | 0.5 | 11 | 17 |
| 8 | | 1.0 | | | | | 0.6 | 1.4 | 0.5 | 11 | 9 |
| 9 | | 1.5 | | | | | 0.6 | 1.8 | 0.5 | 11 | 14 |
| 10 | | 1.7 | | | | | 0.6 | 1.9 | 0.5 | 11 | 93 |
| 11 | LiFOB | 0.21 | PSAH | 1 | LiPF₆ | 15 | 0.6 | 0.8 | 0.5 | 11 | 60 |
| 12 | | 0.35 | | | | | 0.6 | 0.9 | 0.5 | 11 | 12 |
| 13 | | 0.70 | | | | | 0.6 | 1.4 | 0.5 | 11 | 8 |
| 14 | | 1.05 | | | | | 0.6 | 1.8 | 0.5 | 11 | 15 |
| 15 | | 1.19 | | | | | 0.6 | 1.9 | 0.5 | 11 | 37 |

TABLE 2
Positive electrode active material: LiNi_{0.80}Co_{0.15}Al_{0.05}O₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 16 | LiBOB | 0.15 | PSAH | 1 | LiPF₆ | 15 | 0.6 | 0.8 | 0.5 | 9 | 74 |
| 17 | | 0.25 | | | | | 0.6 | 0.9 | 0.5 | 9 | 12 |
| 18 | | 0.50 | | | | | 0.6 | 1.4 | 0.5 | 9 | 6 |
| 19 | | 0.75 | | | | | 0.6 | 1.8 | 0.5 | 9 | 18 |
| 20 | | 0.85 | | | | | 0.6 | 1.9 | 0.5 | 9 | 95 |
| 21 | LiBF₄ + | 0.2 | PSAH | 1 | LiPF₆ | 15 | 0.6 | 0.8 | 0.5 | 10 | 52 |
| 22 | LiBOB | 0.4 | | | | | 0.6 | 0.9 | 0.5 | 10 | 14 |
| 23 | | 0.7 | | | | | 0.6 | 1.4 | 0.5 | 10 | 8 |
| 24 | | 1.1 | | | | | 0.6 | 1.8 | 0.5 | 10 | 19 |
| 25 | | 1.3 | | | | | 0.6 | 1.9 | 0.5 | 10 | 69 |
| 26 | LiBF₄ | 1 | PSAH | 0.3 | LiPF₆ | 15 | 0.6 | 1.2 | 0.3 | 9 | 52 |
| 27 | | | | 0.5 | | | 0.6 | 1.2 | 0.4 | 9 | 14 |
| 28 | | | | 1.0 | | | 0.6 | 1.2 | 0.8 | 9 | 8 |
| 29 | | | | 1.5 | | | 0.6 | 1.2 | 1.2 | 9 | 19 |
| 30 | | | | 1.8 | | | 0.6 | 1.2 | 1.3 | 9 | 69 |

TABLE 3
Positive electrode active material: LiNi_{0.80}Co_{0.15}Al_{0.05}O₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 31 | LiBF₄ | 1 | ESAH | 0.3 | LiPF₆ | 15 | 0.6 | 1.2 | 0.3 | 9 | 80 |
| 32 | | | | 0.5 | | | 0.6 | 1.2 | 0.4 | 9 | 17 |
| 33 | | | | 1.0 | | | 0.6 | 1.2 | 0.8 | 9 | 9 |
| 34 | | | | 1.5 | | | 0.6 | 1.2 | 1.2 | 9 | 14 |
| 35 | | | | 1.8 | | | 0.6 | 1.2 | 1.3 | 9 | 93 |
| 36 | LiBF₄ | 1 | PBS | 0.32 | LiPF₆ | 15 | 0.6 | 1.2 | 0.3 | 9 | 60 |
| 37 | | | | 0.53 | | | 0.6 | 1.2 | 0.4 | 9 | 12 |
| 38 | | | | 1.05 | | | 0.6 | 1.2 | 0.8 | 9 | 8 |
| 39 | | | | 1.58 | | | 0.6 | 1.2 | 1.2 | 9 | 15 |
| 40 | | | | 1.89 | | | 0.6 | 1.2 | 1.3 | 9 | 37 |
| 41 | LiBF₄ | 1 | PSAH + | 0.31 | LiPF₆ | 15 | 0.6 | 1.2 | 0.3 | 9 | 90 |
| 42 | | | PBS | 0.51 | | | 0.6 | 1.2 | 0.4 | 9 | 19 |
| 43 | | | | 1.03 | | | 0.6 | 1.2 | 0.8 | 9 | 10 |
| 44 | | | | 1.54 | | | 0.6 | 1.2 | 1.2 | 9 | 16 |
| 45 | | | | 1.85 | | | 0.6 | 1.2 | 1.3 | 9 | 80 |

TABLE 4
Positive electrode active material: LiNi_{0.80}Co_{0.15}Al_{0.05}O₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 46 | LiBF₄ | 1 | PSAH | 1 | LiPF₆ | 3 | 0.6 | 0.9 | 0.5 | 7 | 60 |
| 47 | | | | | | 5 | 0.6 | 0.9 | 0.5 | 8 | 12 |
| 48 | | | | | | 15 | 0.6 | 0.9 | 0.5 | 11 | 8 |
| 49 | | | | | | 25 | 0.6 | 0.9 | 0.5 | 13 | 15 |
| 50 | | | | | | 30 | 0.6 | 0.9 | 0.5 | 15 | 37 |
| 51 | LiBOB | 0.5 | PSAH | 1 | LiPF₆ | 4 | 0.6 | 0.9 | 0.5 | 7 | 90 |
| 52 | | | | | | 6 | 0.6 | 0.9 | 0.5 | 8 | 19 |
| 53 | | | | | | 16 | 0.6 | 0.9 | 0.5 | 11 | 10 |
| 54 | | | | | | 26 | 0.6 | 0.9 | 0.5 | 13 | 16 |
| 55 | | | | | | 31 | 0.6 | 0.9 | 0.5 | 15 | 80 |
| 56 | LiBF₄ | 1 | PSAH | 1 | LiFSI | 3.6 | 0.6 | 0.9 | 0.5 | 7 | 74 |
| 57 | | | | | | 6 | 0.6 | 0.9 | 0.5 | 8 | 15 |
| 58 | | | | | | 18 | 0.6 | 0.9 | 0.5 | 11 | 6 |
| 59 | | | | | | 30 | 0.6 | 0.9 | 0.5 | 13 | 18 |
| 60 | | | | | | 36 | 0.6 | 0.9 | 0.5 | 15 | 95 |

TABLE 5
Positive electrode active material: LiNi_{0.80}Co_{0.15}Al_{0.05}O₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 61 | LiBF₄ | 1 | PSAH | 1 | LiPF₆ + | 4.1 | 0.6 | 0.9 | 0.5 | 7 | 80 |
| 62 | | | | | LiFSC | 6.8 | 0.6 | 0.9 | 0.5 | 8 | 17 |
| 63 | | | | | | 20.3 | 0.6 | 0.9 | 0.5 | 11 | 9 |
| 64 | | | | | | 33.8 | 0.6 | 0.9 | 0.5 | 13 | 14 |
| 65 | | | | | | 40.6 | 0.6 | 0.9 | 0.5 | 15 | 93 |
| 66 | — | — | — | — | — | — | 0.4 | 0.1 | — | 0.1 | 80 |
| 67 | | | | | | | 0.5 | 0.1 | — | 0.1 | 93 |
| 68 | | | | | | | 0.6 | 0.1 | — | 0.1 | 83 |
| 69 | | | | | | | 0.8 | 0.1 | — | 0.1 | 90 |
| 70 | | | | | | | 0.9 | 0.1 | — | 0.1 | 88 |

As described in Tables 1 to 5, the swelling rate of the secondary battery in which the positive electrode 11 included the lithium-nickel composite oxide as the positive electrode active material varied greatly depending on the physical property (the intensity ratios I, IBN, ISN, and IFN) of the positive electrode 11.

Specifically, in a case where the stabilization process was performed on the secondary battery in which the electrolytic solution did not include the boron-containing compound, the sulfur-containing compound, and the fluorine-containing compound (Experiment examples 66 to 70), not all of the six XPS spectra were detected. It was therefore not possible to calculate all of the four intensity ratios.

In contrast, in a case where the stabilization process was performed on the secondary battery in which the electrolytic solution included the boron-containing compound, the sulfur-containing compound, and the fluorine-containing compound (Experiment examples 1 to 65), all of the six XPS spectra were detected. It was therefore possible to calculate all of the four intensity ratios.

Accordingly, in the case where the electrolytic solution did not include the boron-containing compound, the sulfur-containing compound, and the fluorine-containing compound (Experiment examples 66 to 70), the swelling rate increased markedly.

In contrast, in the case where the electrolytic solution included the boron-containing compound, the sulfur-containing compound, and the fluorine-containing compound (Experiment examples 1 to 65), the swelling rate decreased. In this case, the swelling rate further decreased in a case where all of the following four conditions were satisfied (for example, Experiment examples 2 to 4) as compared with a case where not all of the four conditions were satisfied (for example, Experiment examples 1 and 5); thus, the swelling rate decreased markedly in the case where all of the four conditions were satisfied. The four conditions were: that the intensity ratio IO was within a range from 0.5 to 0.8 both inclusive; the intensity ratio IBN was within a range from 0.9 to 1.8 both inclusive; the intensity ratio ISN was within a range from 0.4 to 1.2 both inclusive; and the intensity ratio IFN was within a range from 8 to 13 both inclusive.

### Experiment Examples 71 and 72

For comparison, as presented in Table 6, the secondary batteries were fabricated by a similar procedure except that, as the positive electrode active material, lithium cobalt oxide (LiCoO₂) which is not the lithium-nickel composite oxide was used, and the swelling characteristic of the secondary battery was evaluated.

TABLE 6
Positive electrode active material: LiCoO₂

| | Boron- | | Sulfur- | | Fluorine- | | | | | | |
|---|---|---|---|---|---|---|---|---|---|---|---|
| | containing | | containing | | containing | | | | | | |
| | compound | | compound | | compound | | | | | | |
| Experiment | | Content | | Content | | Content | Intensity ratio | | | | Swelling |
| example | Kind | (wt %) | Kind | (wt %) | Kind | (wt %) | IO | IBN | ISN | IFN | rate (%) |
| 66 | — | — | — | — | — | — | 0.4 | 0.1 | — | 0.1 | 80 |
| 48 | LiBF₄ | 1 | PSAH | 1 | LiPF₆ | 15 | 0.6 | 0.9 | 0.5 | 11 | 8 |
| 71 | — | — | — | — | — | — | — | — | — | — | 85 |
| 72 | LiBF₄ | 1 | PSAH | 1 | LiPF₆ | 15 | 0.4 | 0.1 | — | 0.1 | 25 |

As presented in Table 6, in the secondary battery which did not include the lithium-nickel composite oxide as the positive electrode active material (Experiment examples 71 and 72), the swelling rate decreased in a case where the electrolytic solution included the boron-containing compound, the sulfur-containing compound, and the fluorine-containing compound (Experiment example 72) as compared with a case where the electrolytic solution did not include the boron-containing compound, the sulfur-containing compound, and the fluorine-containing compound (Experiment example 71).

However, the swelling rate of the case where the lithium-nickel composite oxide was not used as the positive electrode active material (Experiment example 72) was more than three times the swelling rate of the case where the lithium-nickel composite oxide was used as the positive electrode active material (Experiment example 48). Accordingly, the former swelling rate did not decrease sufficiently as compared with the latter swelling rate.

A reason for this is considered to be attributed to a difference in the kind of the positive electrode active material. That is, an advantageous tendency that the swelling rate decreases markedly in the case where all of the four conditions (the intensity ratio IO is within a range from 0.5 to 0.8 both inclusive, the intensity ratio IBN is within a range from 0.9 to 1.8 both inclusive, the intensity ratio ISN is within a range from 0.4 to 1.2 both inclusive, and the intensity ratio IFN is within a range from 8 to 13 both inclusive) are satisfied is a particular tendency that is not achievable in the case where no lithium-nickel composite oxide is used as the positive electrode active material, and is achievable only in the case where the lithium-nickel composite oxide is used as the positive electrode active material.

Based upon the results presented in Tables 1 to 6, the swelling rate decreased markedly in a case where, in the secondary battery in which the positive electrode 11 included the lithium-nickel composite oxide, the six XPS spectra (the first O1s spectrum, the second O1s spectrum, the B1s spectrum, the S2p spectrum, the F1s spectrum, and the Ni3p spectrum) were detectable by the surface analysis of the positive electrode 11 by XPS, and where the four intensity ratios (the intensity ratios IO, IBN, ISN, and IFN) satisfied the above-described conditions. Accordingly, a superior swelling characteristic of the secondary battery was obtained.

Although the present technology has been described herein, the configuration of the present technology is not limited thereto, and is therefore modifiable in a variety of suitable ways.

For example, although the description has been given of the case where the secondary battery has a battery structure of the laminated-film type, the battery structure is not particularly limited, and may thus be of any other type, such as a cylindrical type, a prismatic type, a coin type, or a button type.

Further, although the description has been given of the case where the battery device has a device structure of a wound type, the device structure of the battery device is not particularly limited, and may thus be of any other type, such as a stacked type in which the electrodes (the positive electrode and the negative electrode) are stacked or a zigzag folded type in which the electrodes (the positive electrode and the negative electrode) are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

1. A secondary battery comprising:
a positive electrode including a lithium-nickel composite oxide;
a negative electrode; and
an electrolytic solution, wherein
a first O1s spectrum, a second O1s spectrum, a b1s spectrum, a S2p spectrum, a F1s spectrum, and a Ni3p spectrum are detectable by a surface analysis of the positive electrode by X-ray photoelectron spectroscopy, the first O1s spectrum having a peak within a range of binding energy that is greater than or equal to 528 electron volts and less than or equal to 531 electron volts, the second O1s spectrum having a peak within a range of binding energy that is greater than 531 electron volts and less than or equal to 535 electron volts,
a ratio of an intensity of the first O1s spectrum to an intensity of the second O1s spectrum is greater than or equal to 0.5 and less than or equal to 0.8,
a ratio of an intensity of the b1s spectrum to an intensity of the Ni3p spectrum is greater than or equal to 0.9 and less than or equal to 1.8,
a ratio of an intensity of the S2p spectrum to the intensity of the Ni3p spectrum is greater than or equal to 0.4 and less than or equal to 1.2, and
a ratio of an intensity of the F1s spectrum to the intensity of the Ni3p spectrum is greater than or equal to 8 and less than or equal to 13.

2. The secondary battery according to claim 1, wherein
the positive electrode includes
a positive electrode active material layer including the lithium-nickel composite oxide, and
a film provided on a surface of the positive electrode active material layer, the film including boron, sulfur, and fluorine as constituent elements, and
the surface analysis of the positive electrode by the X-ray photoelectron spectroscopy comprises an analysis of the film.

3. The secondary battery according to claim 1, wherein the lithium-nickel composite oxide includes a compound represented by Formula (1) below,
Li_{w}Ni_{(1-x-y-z)}CoₓM1_{y}M2_{z}O₂ (1)
where
M1 is Al, Mn, or both,
M2 is at least one of elements belonging to groups 2 to 15 in a long period periodic table of elements excluding Ni, Co, Al, and Mn,
w, x, y, and z satisfy 0.8≤w≤1.2, 0<x≤0.3, 0≤y≤0.1, and 0≤z≤0.1,
a composition of lithium differs depending on a charge and discharge state, and
w is a value of a fully discharged state.

4. The secondary battery according to claim 1, wherein the electrolytic solution includes
a boron-containing compound,
a sulfur-containing compound, and
a fluorine-containing compound.

5. The secondary battery according to claim 4, wherein
the boron-containing compound includes a boron-containing lithium salt,
the sulfur-containing compound includes a cyclic disulfonic acid anhydride, an alkynyl sulfonic acid, or both, and
the fluorine-containing compound includes a fluorine-containing lithium salt.

6. The secondary battery according to claim 1, further comprising an outer package member having flexibility and containing the positive electrode, the negative electrode, and the electrolytic solution.

7. The secondary battery according to claim 1, wherein the secondary battery comprises a lithium-ion secondary battery.
